(19) United States
(12) Patent Application Publication
(10) Pub. No.: US 2012/0050522 A1
(43) Pub. Date: Mar. 1, 2012

(54) METHOD OF AND APPARATUS FOR VERIFYING ASSEMBLY COMPONENTS OF A MOBILE DEVICE

(75) Inventors: Tyler Jaffery Van Slyck, Waterloo (CA); Ranjeet Jheeta, Kitchener (CA); David John Wegscheider, Waterloo (CA)

(73) Assignee: RESEARCH IN MOTION LIMITED, Waterloo (CA)

(21) Appl. No.: 12/862,450

(22) Filed: Aug. 24, 2010

(51) Int. Cl. G06K 9/00; H04N 7/18

(52) U.S. Cl. 348/92; 382/141; 348/E07.085

(57) ABSTRACT

A method and apparatus for verifying the assembly components of a mobile device includes a camera module communicatively coupled to processing module. The processing module is programmed to receive a first image of at least a partially-assembled device having at least two components. The processing module is also programmed to compare the first image with a first validation image of at least a partially-assembled device. Based on the comparison of the first image and the first validation image, the processing module can approve the partially-assembled device for further assembly. In one implementation, the processing module can be programmed to generate a certification code in the event the comparison of the components in the first image and the components of the first validation image are substantially equivalent. If the partially-assembled device is approved, assembly is continued. If the partially-assembled device is not approved, assembly is discontinued.

### FIELD OF TECHNOLOGY

The present disclosure relates generally to methods of verifying assembly components. More specifically, the present disclosure relates to verifying assembly components of a mobile device.

### BACKGROUND

Production lines are sets of sequential operations where materials and components are assembled to make an end-product. Multiple product variants can be assembled using the same production line. For example, the multiple product variants can be assembled using the same or substantially similar components, but can differ in the colors of the components, differ in having an extra component such as a camera, differ in type of processors, differ in type of displays, differ in type of keyboards, differ in shapes of the keyboard keys, differ in ornamental designs, differ in branding or logos, or any other variant. Additionally, each product variant can be customer-specific. In other words, one product variant can be unique to a specific customer.

### BRIEF DESCRIPTION OF THE DRAWINGS

Implementations of the present disclosure will now be described, by way of example only, with reference to the attached Figures, wherein:

FIG. 1 is an illustration of an apparatus for verifying assembly components of a mobile device in accordance with an exemplary implementation described herein;

FIG. 2 is a schematic illustration of an alternative implementation of an apparatus for verifying assembly components of a mobile device illustrating a camera module coupled to a processing module;

FIG. 3 is an illustration of a first image of a partially-assembled device and a validation image in accordance with an exemplary implementation of a method of verifying assembly components of a mobile device as described herein;

FIG. 4 is an illustration of an alternative implementation of an apparatus for verifying assembly components of a mobile device having a second camera module for capturing images of a partially-assembled device at a second stage of assembly;

FIG. 5 is a flow chart of an exemplary method of verifying assembly components of a mobile device as described herein

FIG. 6 is a flow chart of an alternative implementation of an exemplary method of verifying assembly components of a mobile device as described herein; and

FIG. 7 is a flow chart of another alternative implementation for verifying assembly components of a mobile device as described herein.

### DETAILED DESCRIPTION

As will be appreciated for simplicity and clarity of illustration, where appropriate, reference numerals have been repeated among the different figures to indicate corresponding or analogous elements. In addition, numerous specific details are set forth in order to provide a thorough understanding of the implementations described herein. However, those of ordinary skill in the art will understand that the implementations described herein can be practiced without these specific details. In other instances, methods, procedures and components have not been described in detail so as not to obscure the related relevant feature being described. Also, the description is not to be considered as limiting the scope of the implementations described herein.

Several definitions that apply throughout this document will now be presented. The word “coupled” is defined as connected, whether directly or indirectly through intervening components and is not necessarily limited to physical connections. The term “mobile device” is defined as any electronic device that is capable of at least accepting information entries or commands from a user and includes the electronic device's power source. The term “camera” is defined as any device that is capable of capturing images of object, such as still images or series of moving images. For example, a camera can be a still-picture camera or a video camcorder. The term “marking” is defined as any identifier that distinguishes one component from another. For example, a marking can be a serial number, a part number, a logo, a symbol, a color, or any other similar identifier. The term “product variant” or “device variant” refers to a product that is assembled from components that can be interchanged with other products. For example, a product variant can be a particular model of a product that differs by having additional features, additional components, fewer features, fewer components, different processors, different colored components, components made by different manufacturers, or the like. In another implementation a product can have product variants that include a base model, a special edition model, an upgraded model, a limited edition, or the like. The term “customer-specific” refers to being assembled from components that are specific or unique to a particular customer. For example, the customer can be the end user, the end purchaser, the end supplier, or the carrier of the product. The term “match” refers to a determination that two at least partially-assembled devices of two images or partially-assembled devices have substantially equivalent components. The term “product identification” refers to an identification of a particular product. The product identification can be a code, phrase, or other signifying description. Further definitions will be presented below. The term “memory” refers to transitory memory and non-transitory memory. For example, non-transitory memory can be implemented as Random Access Memory (RAM), Read-Only Memory (ROM), flash, ferromagnetic, phase-change memory, and other non-transitory memory technologies.

For purposes of brevity and as an example, the present disclosure will focus on a method of verifying assembly components of a mobile device. However, one of ordinary skill in the art will appreciate that other devices can be verified according to the present disclosure. For example, the method of verifying assembly components described here can be implemented for verifying assembly components of Personal Digital Assistants (PDAs), handheld global positioning systems (GPSs), netbooks, laptop computers, handheld electronic notebook pads, a remote control, netpads, handheld messaging devices, handheld video players, handheld audio device, handheld MP3 devices, or any other similar device that is assembled from components. Additionally, the method of verifying assembly components described herein can be implemented for verifying assembly components of devices that are assembled from components which can be interchanged with components of other devices or other device variants, such as customer-specific variants or carrier-specific variants. In addition, the method as described herein can be implemented to verify a completely assembled device. While the method as presented herein is generally described in relation to at least a partially assembled device, the disclosure can be implemented with respect to a fully assembled device.

A method of verifying assembly components of a mobile device includes receiving a first image data, at a processing module, of at least a partially-assembled device having at least two components; comparing, at a processing module and in response to the receiving, the first image data with a first validation image of at least a partially-assembled device; and in response to the comparing, generating a certification code in the event the comparison of the components in the first image and the components of the first validation image contain substantially equivalent components. The method of verifying assembly components can also include receiving a request for verification of at least a partially assembled device. The request can thereby initiate the method of verifying assembly components of a mobile device or at least a partially assembled mobile device. A validation apparatus for verifying the assembly components of a mobile device can include a camera module and a processing module communicatively coupled to the camera module. The processing module can be programmed to receive first image data of at least a partially-assembled device having at least two components, compare the first image data with a first validation image of at least a partially-assembled device, and generate a certification code in the event the comparison of components in the first image and the components of the first validation image contain substantially equivalent components.

The method of verifying assembly components can also include selecting a product identification code that indicates a desired finished product. The product identification code can include an identifying phrase, a numeric code, an alphabetic code, an alphanumeric code, or other identifying code. The product identification code signifies the build of the device. The product identification code can be used in conjunction with a database to associate two or more components with the product identification code. The components can be predefined components that can be used in a single product line or across multiple product lines. For example, the product identification code can be used to associate a device with one or more of the following: a particular display, keyboard, end cap, display cover, side cover, back cover and the like. The keyboard can be the same for two or more product identification codes, but different with respect to other product identification codes. For example, the same keyboard can be used on two devices having the same form factor, but not on a third that has the same form factor but requires a keyboard having a different color configuration or the like. Form factor as used herein refers to a device having generally the same shape. Furthermore, the keyboard can vary across the different form factors or can be the same. Additionally, other components can be used similarly across one or more product identification codes.

The database can be configured so that one or more databases are available for associating with a product identification code. For example, the database can be a compilation of individual databases or the individual databases can be accessed directly. In one example, the databases include separate databases for the keyboard, display screen, branding logos, device color, processor, chip components, end cap, back cover, and the like. The databases for each of these components can include images or models. In at least one implementation, the test for each of the components is included within the database. In another implementation, the test for each of the components is separate from the database of images and is assembled in conjunction with the images by the system.

The individual tests and images can be combined together to create a test for a device identified by the selected product identification code. An image of the device having at least two of the components associated with the device is taken. The image is then analyzed by the processing module of the validation apparatus. Test results are generated in light of the analysis. The test results are compared to at least one predetermined value to determine whether the device meets the requirements. A device can be tested after final assembly or before final assembly. Furthermore, the device can be tested at two or more stages of assembly, including final assembly, as described below. Further details of the method and apparatus are described hereinbelow.

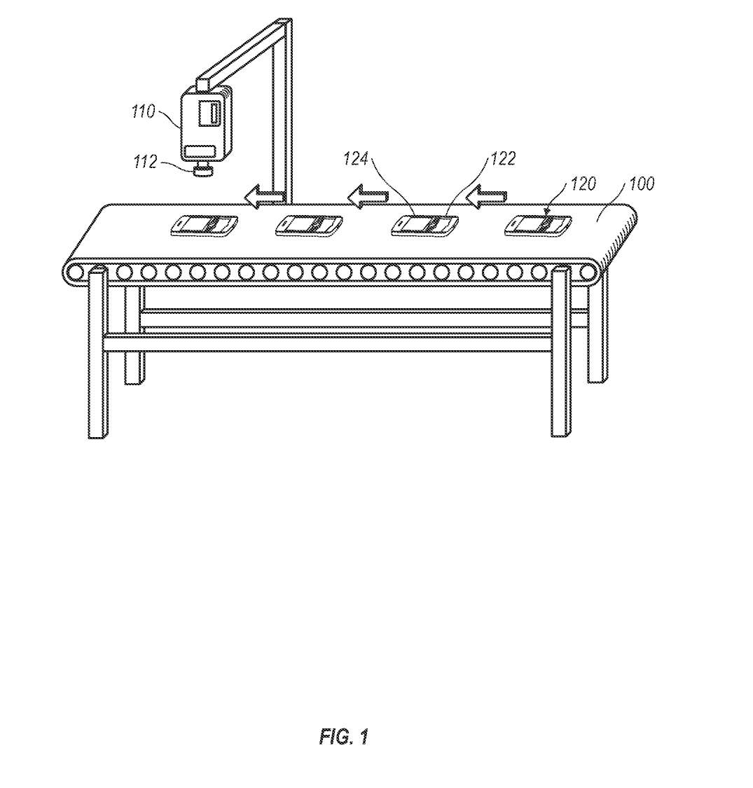

The method and apparatus for verifying assembly components of a mobile device will be described with reference to FIGS. 1-6. FIG. 1 is an illustration of an exemplary implementation of the method and apparatus for verifying assembly components of a device that is a handheld communication device. A camera module 110 is positioned along an assembly line 100 such that the camera module 110 can capture first image data of at least a partially-assembled device 120. In FIG. 1, the camera module 110 is an overhead camera configured to take still-images of partially-assembled devices 120 that travel down the assembly line 100. Additionally, one of ordinary skill in the art will appreciate that the camera module 110 can be a digital camera, a camcorder, or any other image-taking device that can capture images of the at least partially-assembled devices 120 that travel down the assembly line 100.

While the assembly line 100 is shown as a conveyor-belt type assembly line, one of ordinary skill in the art will appreciate that the assembly line 100 can be a specially configured conveyor, a single station assembly line, or the like. As described herein, an assembly line is an apparatus or system constructed to allow for the assembly of devices from various components.

As the mobile devices 120 are assembled, the at least-partially-assembled devices 120 travel down the assembly line 100 towards the camera module 110. The camera module 110 captures a first image of each at least partially-assembled device 120 that passes within the range of the lens 112 of the camera module 110. The images of the at least partially-assembled devices 120 captured by the camera module 110 are compared to a validation image. Based on the comparison of the images captured by the camera module 110 and the validation image, the validation apparatus determines whether the at least-partially-assembled device 120 contains substantially equivalent components as the components in the validation image.

Additionally, based on the comparison of the image taken by the capture module 110 and the validation image, the validation apparatus either completes the assembly of the mobile device or discontinues the assembly of the particular at least partially-assembled mobile device 120 if the at least partially-assembled mobile device does not contain substantially equivalent components as the components in the validation image. For example, if the validation apparatus determines the at least partially-assembled mobile device should not continue for further assembly, the conveyor assembly line 100 can cease movement, and a notification or signal can be sent to the assembly line to indicate a manual review of the at least partially-assembled device 120 is needed or to indicate a manual correction of the failed at least partially-assembled device 120 is needed. Alternatively, if the validation apparatus does not approve the at least partially-assembled device 120 for continued assembly, the apparatus can stop the assembly line for corrective action. Additionally, the mobile device that has been disapproved can be disassembled, scrapped, set aside for manual review, recycled, or the like. In another example, if a predetermined number of failures are detected in a row, the assembly line 100 can be instructed to stop or another type of alarm signal can be sent.

Additionally, while the at least-partially-assembled device 120 illustrated in FIG. 1 is assembled with a body 122 and a display screen 124, one of ordinary skill in the art will appreciate that the at least-partially-assembled device 120 can have other assembled components such as the body 122 assembled with a keyboard, the body 122 assembled with a processor, the body 122 assembled with a keyboard and a display screen 124, the body 122 assembled with a Wi-Fi component, or any other assembly of at least two components of a mobile device. The description herein refers to at least a partially-assembled device. In other implementations, the at least partially-assembled device can be fully-assembled. The at least partially-assembled device denotes the assembly of the mobile device after the assembly of any two components.

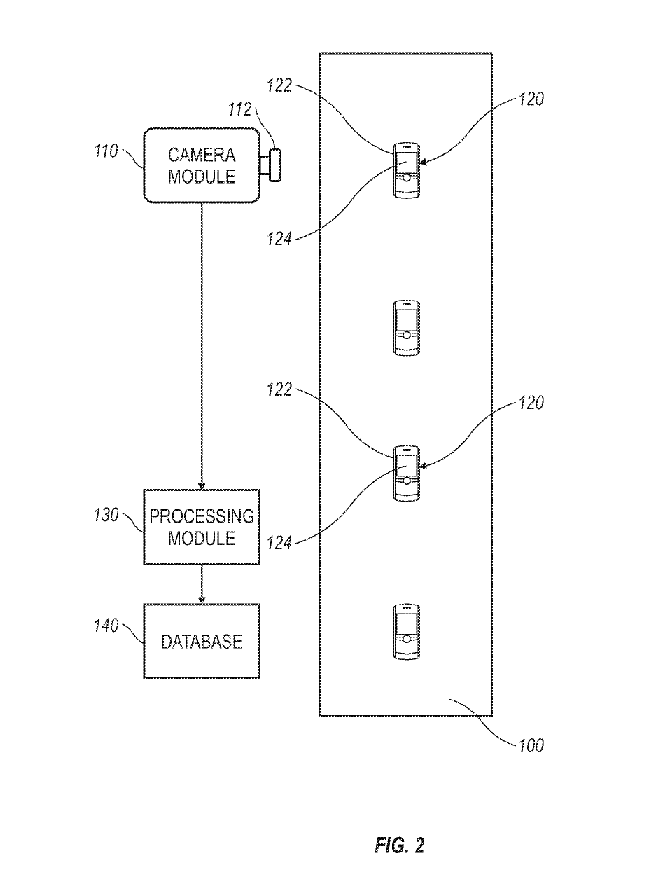

FIG. 2 is a schematic illustration of the validation apparatus for verifying assembly components of a mobile device. In FIG. 2, a camera module 110 is positioned along an assembly line 100 on which partially-assembled devices 120 travel during assembly. The camera module 110 is communicatively coupled to a processing module 130. The processing module 130 is coupled to a database 140 and is programmed to receive a first image of at least a partially-assembled device 120 having at least two components. The processing module 130 is also programmed to compare the first image with a first validation image of at least a partially-assembled device 120. Additionally, the processing module 130 is programmed to generate a certification code in the event the comparison of the components in the first image and the components in the first validation image contain substantially equivalent components. The database 140 can be a storage medium for storing validation images to which the images captured by the module 110 are compared.

In FIG. 2, as the at least-partially-assembled devices 120 travel down the assembly line 100 and pass the lens 112 of the camera module 110, the camera module 110 captures an image of each partially-assembled device 120. In the particular implementation illustrated in FIG. 2, the at least-partially-assembled devices 120 have at least two components: the body 122 and the display screen 124. The image captured by the camera module 110 can be sent to the processing module 130 as image data. The processing module 130 can retrieve a validation image, such as from a database 140 to compare with the image captured by the camera module 110. The processing module compares the components of the at least-partially-assembled device 120 shown in the image captured by the camera module 110 with the components shown in the validation image to determine whether the at least-partially-assembled device 120 is approved or disapproved for continued assembly or completion of assembly. While FIG. 2 illustrates retrieving a validation image from the database 140 coupled to the processing module 130, one of ordinary skill in the art will appreciate that the database 140 can be a remote database to which the processing module 130 is connected via a wireless network, a local database to which the processing model 130 is connected via a wired connection, or a remote database to which the processing module 130 is connected via an Internet, or any other similar database.

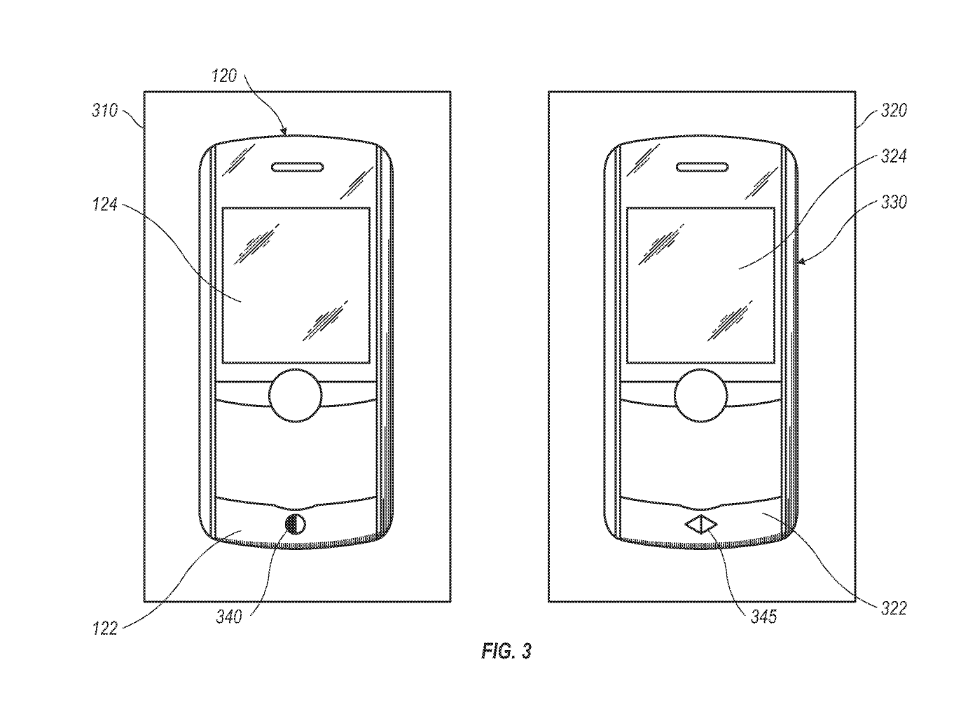

FIG. 3 is an illustration of a first image 310 and a validation image 320 that are compared by the processing module 130 when verifying the assembly components of a mobile device. In FIG. 3, the first image 310 is of the front face of the at least partially-assembled device 120 captured by a camera module 110 positioned on an assembly line on which the at least-partially-assembled device 120 travels. The at least-partially-assembled device 120 has at least two components: the body 122 and the display screen 124. As illustrated in FIG. 3, the body 122 of the at least-partially-assembled device 120 shown in the first image 310 includes a marking 340 towards a bottom portion the at least-partially-assembled device 120. The particular marking 340 illustrated in FIG. 3 is a circle that is half-portion shaded. In at least one implementation, the marking 340 can be any symbol, design, logo, or marking. As shown in FIG. 3, the marking is in a conspicuous place so that the customer and others can recognize the product. In at least one implementation, the marking 340 can be hidden, concealed, or otherwise made difficult to see for an end user or end customer. For example, the marking 340 can be used to identify the manufacturer or supplier of the component, to identify the product as a product variant that is to be shipped to a specific or unique customer or carrier. For example, the mobile device can be provided to two different carriers, but the mobile device provided to a first carrier has a first color scheme and the mobile device provided to a second carrier has a second color scheme different from the first color scheme. In such an implementation, the marking 340 can be used to identify and separate the mobile devices intended for the first carrier from the mobile devices intended for the second carrier.

FIG. 3 also illustrates an example of a validation image 320, to which the processing module 130 of the validation apparatus compares the first image 310. In FIG. 3, the validation image 320 is an image of a partially-assembled validation device 330. The illustrated validation device 330 has two assembled components: the body 322 and the display screen 324. The body 322 includes a marking 345 at the bottom portion of the body 322. The marking 345 is a diamond-shaped design. As described above, the marking 345 can be any other shape, design, logo, or symbol that identifies the particular component or device that is to be assembled. Alternatively, the markings 340, 345 can be a color of a component or a color scheme of the assembled components. The processing module 130 compares the at least-partially-assembled device 120 of the first image 310 with the at least-partially-assembled device 330 of the validation image 320. In at least one implementation, the processing module 130 compares the components of the first image 310 with the components of the validation image 320. In the event the comparison of the components in the first image 310 and the second image 320 match or contain substantially equivalent components, the processing module 130 can generate a certification code. The certification code can be a code indicating that the at least partially-assembled device 120 in the first image 310 is approved for continued assembly to complete the assembly of the device. Alternatively, the certification code can be an indication that the at least partially-assembled device 120 fails verification and is to be discarded from the assembly line. In another implementation, the certification code can include a customer identifier associated with a particular customer associated to whom the assembled device will be shipped.

While FIG. 3 illustrates the validation image 320 as an image of a partially-assembled device 330, one of ordinary skill in the art will appreciate that the image can be of a completely-assembled device, individual images of one or more of the components that form a mobile device, an image derived from a model of the device, an approved image taken of an approved mobile device having at least one component assembled in a desired configuration, or any other image that can be used to compare the image captured by the camera module 110 that will verify that the at least-partially-assembled device 120 includes the appropriate components required to form the desired mobile device. Further details of the validation image 320 will be described in later passages herein.

Additionally, the first image 310 can be an image of the entire partially-assembled device 120, an image of the bottom of the at least-partially-assembled device 120, an image of a particular component of the at least-partially-assembled device 120, an image of the at least-partially-assembled device 120 at a first stage, an image of the at least-partially-assembled device 120 at a later stage, an image of the side face of the device, an image of an interior surface of the device, or any other image of the at least-partially-assembled device 120 that permits the processing module 130 to determine whether the at least-partially-assembled device 120 should continue to assembly completion.

Furthermore, while FIG. 3 illustrates comparing the marking 340 on a partially-assembled device 120 captured by the camera module 110 to the marking 345 on a partially-assembled validation device 330, one of ordinary skill in the art will appreciate that other comparisons can be made to determine whether the at least-partially-assembled device 120 on the assembly line 100 should continue to completion of assembly. For example, the first image 310 and the validation image 320 can be compared to determine whether a particular component of the mobile device is in a desired configuration. In at least one implementation, the first image 310 can be compared to the validation image 320 to determine whether a trackball navigation tool of the at least partially-assembled device 120 is configured in the desired position which is shown in the validation image 320, for example between the display screen and the keyboard of the mobile device. In another implementation, the first image 310 and the validation image 320 can be compared to determine whether the at least partially-assembled device 120 on the assembly line 100 includes the same components as the components found on the validation image 320. For example, the at least partially-assembled device 120 depicted in the first image 310 can have a display screen, a keyboard, and a processor; and the device depicted in the validation image 320 can have a display screen, a keyboard, a processor, and Wi-Fi component. The comparison of the first image 310 and the validation image 320 does not result in a match as the partially-assembled device does not include a Wi-Fi component, and the validation apparatus can discontinue assembly of the at least-partially-assembled device, discard the at least-partially-assembled device, transmit an alert for a manual review and correction of the at least-partially-assembled device, or the like.

In other implementations to be described in later paragraphs, the first image 310 can be compared to the validation image 320 to determine whether the shape of components in the first image 310 match the shape of the components in the validation image 320, whether the size of the components in the first image 310 match the size of the components in the validation image 320, whether the components of the at least-partially-assembled device 120 on the assembly line 100 is the same color as the partially-assembled validation device 330, or whether the distance between components in the first image 310 match the distance between similar components in the validation image 320. One of ordinary skill in the art will appreciate that the comparison between the first image 310 and the validation image 320 permits the processing module 130 to determine whether the at least-partially-assembled device 120 on the assembly line 100 should continue to assembly completion.

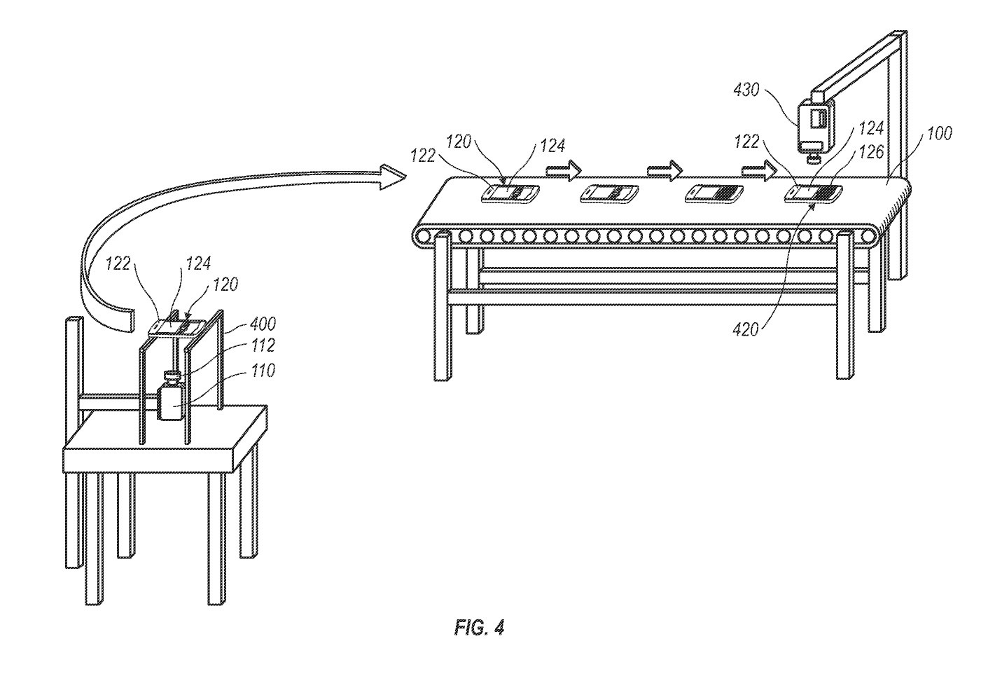

FIG. 4 is an illustration of an alternative implementation of the method for verifying assembly components of a mobile device described herein. In FIG. 4, two stages of image retrieval are illustrated. A partially-assembled device 120 assembled with a display screen 124 and a body 122 is placed on a frame 400. The frame can be a pair of legs on which the at least-partially-assembled device 120 rests. Beneath the frame 400 is a first camera module 110 positioned to capture images of the at least-partially-assembled device 120 placed on the frame 400. The at least-partially-assembled device 120 is placed on the frame 400 such that the camera lens 112 of the first camera module 110 can capture images of all or part of the at least-partially-assembled device 120. In the illustrated implementation of FIG. 4, the first camera module 110 captures images of the bottom of the at least-partially-assembled device 120. While FIG. 4 illustrates the at least-partially-assembled device 120 placed between a pair of legs of a frame 400, one of ordinary skill in the art will appreciate that the at least-partially-assembled device 120 can be placed on a clear table or on any surface or structure that permits a first camera module 110 on a bottom side of the at least-partially-assembled device 120 to capture images of the at least-partially-assembled device 120 for comparison with a validation image. Alternatively, the at least-partially-assembled device 120 can be placed on a frame that can change the position of the at least-partially-assembled device 120 on the frame 100 such that the first camera module 110 can capture an image of the top and the bottom of the at least-partially-assembled device 120 before permitting the at least-partially-assembled device 120 to continue along the assembly line. In another implementation, the at least-partially-assembled device 120 can be placed on a frame that places the at least-partially-assembled device 120 onto the assembly line 100 after the first camera module 110 captures an image of the bottom of the at least-partially-assembled device 120 so that the front of the at least-partially-assembled device 120 faces upwardly on the assembly line 100.

In FIG. 4, the first camera module 110 can be coupled to a first processing module (not shown) that is programmed to a receive a first image of the at least partially-assembled device 120, compare the first image with a first validation image, and generate a certification code permitting the continued assembly of the at least-partially-assembled device 120 in the event the comparison of the components in the first image and the components of the validation image contain substantially equivalent components. If the first processing module generates a first certification code of the first image captured by the first camera module 110 to approve the at least-partially-assembled device 120 for continued assembly, the at least-partially-assembled device 120 can be transferred to the assembly line 100 for further assembly. In the illustrated implementation, the at least-partially-assembled device 120 is further assembled to include a keyboard 126. The at least-partially-assembled devices 120 assembled with keyboards 126 are illustrated on the upper right-hand side of FIG. 4; however, the assembly of the keyboard 126 to the partially-assembled device 120 has been omitted for clarity and brevity.

In the illustrated implementation in FIG. 4, a second camera module 430 can capture a second image of the further-assembled device 420 at a later stage than at the time the first image is captured. The second image can be received by a second processing module (not shown) coupled to the second camera module 430. In at least one implementation, the second processing module coupled to the second camera module 430 can be different from the first processing module coupled to the first camera module 110. While the below description is in relation to having each camera module 430 coupled to individual processing modules, in another implementation, the first camera module 110 and the second camera module 430 can be coupled to the same processing module.

In FIG. 4, the second processing module can compare the second image of the further-assembled device 420 with a second validation image. The second processing module can generate a second certification code in the event the comparison of the components in the second image the components of the second validation image contain substantially equivalent components. The second certification code can indicate the approval of the further-assembled device 420 for continued assembly. Alternatively, the second certification code can indicate approval of the completion of assembly of the mobile device and the approval for distribution of the mobile device to a customer or carrier.

While the illustrated implementation in FIG. 4 illustrates two camera modules 110, 430, one of ordinary skill in the art will appreciate that a single camera module can capture the first image of the at least-partially-assembled device 120 and the second image of the further-assembled device 420. For example, a single camera module can be positioned on the assembly line 100 at a location of the first stage of partial assembly of the mobile device and can then be moved to a position further along the assembly line 100 at a location of the second stage of further assembly of the mobile device.

Additionally, while the illustrated implementation in FIG. 4 illustrates two camera modules 110, 430 placed at different stages along the assembly line 100, one of ordinary skill in the art will appreciate that the apparatus for verifying the assembly components of a mobile device can include a plurality of camera modules positioned at one stage of the assembly line 100. For example, two camera modules can be placed at the beginning of the assembly line at a first stage. The first camera module can be positioned to capture an image of the front face of the at least-partially-assembled device. The second camera module can be positioned to capture a side face of the at least-partially-assembled device. The images captured by the first camera module and the second camera module can be compared to a single validation image or a plurality of validation images to determine whether the components depicted in the image from the first camera module and in the image from the second camera module contain substantially equivalent components as the components depicted in the validation image(s). Similarly, in another implementation, a plurality of camera modules can be placed on a single assembly station. For example, a single assembly station can be an apparatus where a mobile device is completely assembled in one place. In the implementation of the validation apparatus for a single assembly station, the camera modules can be positioned anywhere on the single assembly station to capture images of various sections and components of the at least partially-assembled device. The images captured by the camera modules can then be compared to validation images to determine whether assembly of the at least-partially-assembled device should continue.

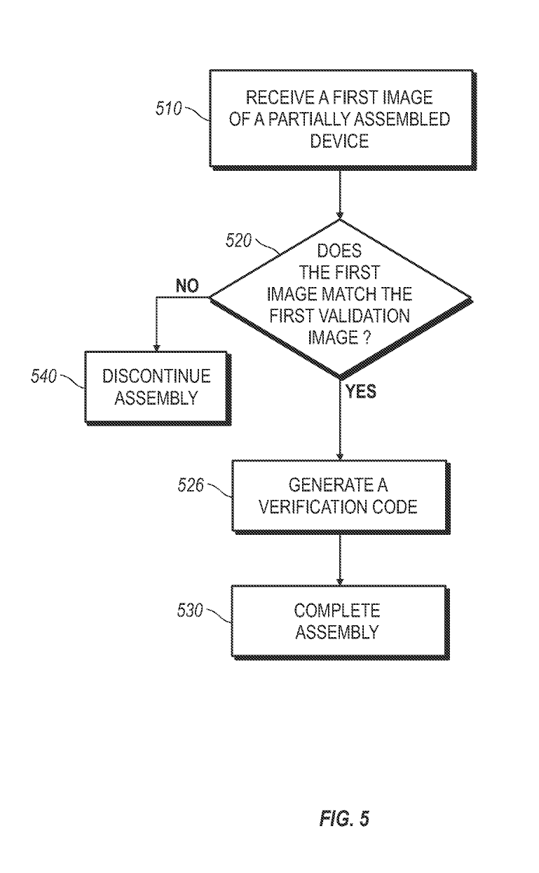

FIG. 5 is a flow chart of an exemplary implementation of the method of verifying assembly components of a mobile device as illustrated in FIGS. 1-4. At block 510, the method includes receiving a first image of an at least partially-assembled device. In one implementation of the method, the processing module receives the first image. Additionally, the first image can be an image of the at least partially-assembled device having at least two components. At block 520, the method includes comparing the first image to a first validation image. The same processing module that receives the first image can also compare the first image to a first validation image. The validation image can be stored on a storage medium of the processing module, stored on a database coupled to the processing module, stored on a third-party network that is accessible via the internet, or stored on a remote database or storage medium that is accessible via a local area network or other communication link. When the processing module receives the first image from the camera module, the processing module can retrieve the appropriate validation image to which to compare the first image of the at least-partially-assembled device. The retrieval of the validation image can signify a stage of assembly identification or verification in the assembly process.

In at least one implementation, the validation image can be an image of a partially-assembled device that has already been approved or verified. For example, the image can be of a device that had been previously approved for further assembly and has already been assembled and shipped to a customer. In another implementation, the validation image can be a series of one or more components of a mobile device that are approved for assembly with the mobile device. For example, the validation can be images of customer-specific components that are to be included in the final assembled device. In yet another implementation, the validation image can be an image derived from a model of the mobile device. For example, the model can be a computer aided design drawing, a photograph of a prototype of the desired mobile device, or any other similar image that depicts the desired assembly and configuration of components of the desired mobile device. Alternatively, the validation image can be an image derived from a model of an individual component to be assembled in the desired mobile device. In another implementation, the validation image can be an approved image that depicts an approved mobile device having at least one component in a desired configuration.

Returning to the implementation of the method illustrated in FIG. 5, in the event the comparison of the components in the first image and the components of the first validation image contain substantially equivalent components, a match is determined between the at least-partially-assembled device and the mobile device in the first validation image. If a match is determined, a verification code can be generated at block 526. The verification code can be an indicator that the at least-partially-assembled device has been approved for further assembly or completion of assembly. The at least-partially-assembled device can continue along the assembly line and complete assembly at block 530. If however, no match is determined at block 520, the at least-partially-assembled device is not approved for further assembly, and assembly of the mobile device is discontinued. In at least one implementation, at block 540, the at least-partially-assembled device that has not been approved for further assembly can be discarded from the assembly line or otherwise handled as described above. While the verification code has been described as providing an indication of a pass/fail for individual validations along the assembly line, the verification code can also provide an indication of a pass/fail for the final assembly of the device. For example, the verification code can provide specific details as to the pass/fail for individual validation tests as well as the overall validation test of the device.

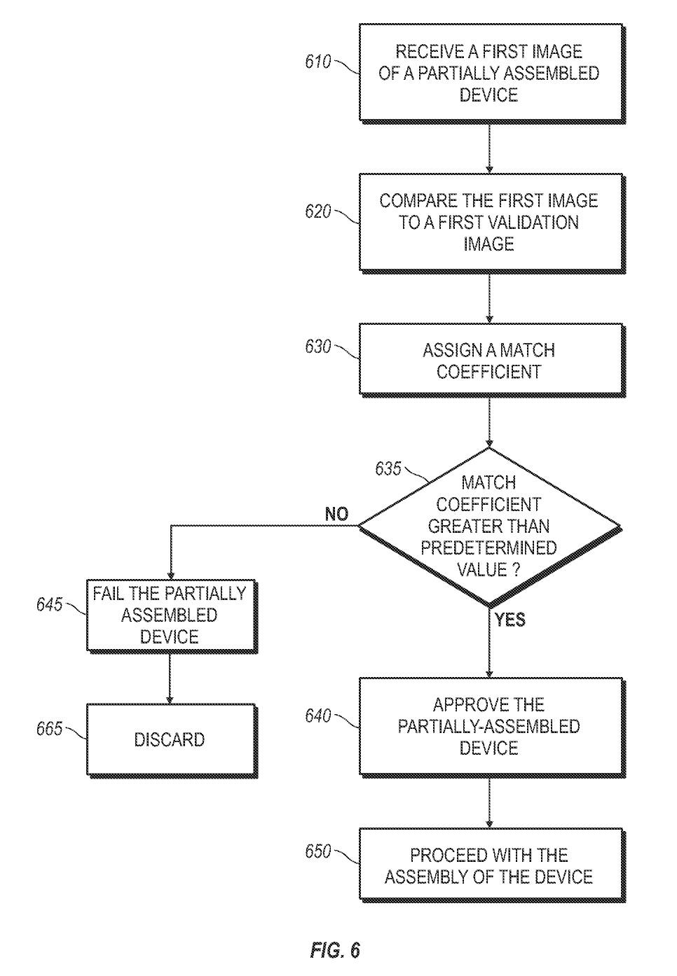

FIG. 6 is a flow chart of an alternative implementation of a method of verifying assembly components of a mobile device. The method illustrated in FIG. 6 is similar to the method described above in relation to FIG. 5 in that the method includes receiving a first image of a partially-assembled device, at block 510, and comparing the first image to a first validation image, at block 620. The alternative method diagrammed in FIG. 6 further includes assigning a match coefficient, at block 630, after a comparison of the first image to the first validation image is made. The match coefficient can be a value that is based upon the difference between the components in the first image of the at least-partially-assembled device and the first validation image. In at least one implementation, at block 635, the match coefficient is compared to a predetermined value. If the match coefficient exceeds the predetermined value, a determination is made that the first image matches the first validation image, and the at least-partially-assembled device is approved for continued assembly, at block 640. If the at least-partially-assembled device is approved, the at least-partially-assembled device continues along the assembly line for further assembly, at block 650, or for completion of assembly. However, if the match coefficient does not exceed the predetermined value, no match is determined, and the at least-partially-assembled device fails verification of the assembly components, at block 645. If the at least-partially-assembled device fails verification, the failed partially-assembled device can be discarded and removed from the assembly line, at block 655. While the implementation of the method of verifying assembly components of a mobile device diagrammed in FIG. 6 describes approval or failure a partially-assembled device based upon a match coefficient, one of ordinary skill in the art will appreciate that the approval or failure of the at least-partially-assembled device can be at least partially based upon the match coefficient and can be based upon other parameters or factors. For example, the approval or failure of the at least-partially-assembled device can also be at least partially based upon a measurement of the color of the at least-partially-assembled device which can be compared to the desired color an approved mobile device.

In either exemplary implementation of the method for verifying assembly components described above, the method of verifying assembly components can be initiated by receiving a request for verification of at least a partially assembled device at the verification apparatus. For example, in at least one implementation, the request can be inputted at a workstation or a computer in control of the verification apparatus. The input can then be relayed to the verification apparatus to begin the method of verifying assembly components of a device, as described herein.

In either exemplary implementation of the method for verifying assembly components described above, the comparison of components in the first image to the components in the first validation image can be a comparison of the color scheme of the at least-partially-assembled device depicted in the first image and the color scheme of the mobile device or components in the validation image. For example, if a carrier is the only carrier that supplies the mobile device having a white body and an orange keyboard, and the at least-partially-assembled device depicted in the first image has a white body and a purple keyboard, the comparison would result in a failed partially-assembled device. The failed partially-assembled device can be removed from the assembly line or discarded thereby ensuring a mobile device that does not meet the specifications of the carrier is not mixed in with the approved mobile devices that do meet the specifications of the carrier.

Alternatively, the comparison of the components in the first image to the components in the validation image can be a comparison of a marking on one or more of the components with the components of the validation image. For example, the first image can be an image of the serial number of a component, such as a processor chip, of the at least-partially-assembled device, and the validation image can be an image of the serial number of the processor chip of an approved mobile device. If the serial number in the first image matches the serial number in the validation image, a match can be determined and the at least-partially-assembled device can be approved for further assembly or completion of assembly. If there is no match, assembly of the at least-partially-assembled device is discontinued and the failed partially-assembled device can be discarded.

In another implementation, the comparison of the components in the first image to the components in the validation image can be a comparison of logos imprinted on housings of the at least-partially-assembled device and the approved mobile device. For example, the first image can be of a logo imprinted on the housing of the at least-partially-assembled device, and the validation image can depict a logo imprinted on the housing of an approved mobile device or an approved component for the approved mobile device. If the logo in the first image matches the logo of the validation image, a match can be determined, and the at least-partially-assembled device can be approved for further assembly or completion of assembly. If there is no match, assembly of the at least-partially-assembled device is discontinued, and the failed partially-assembled device can be discarded.

In yet another implementation, the comparison of the components in the first image with the components in the validation image can be a comparison of the shapes of the components or the sizes of the components. If the shapes or the sizes of the components in the first image match the shapes or the sizes of the components in the validation image, a match can be determined, and the at least-partially-assembled device can be approved for further assembly or completion of assembly. If there is no match, assembly of the at least-partially-assembled device is discontinued, and the failed partially-assembled device can be discarded.

In another implementation, the comparison of the components in the first image with the components in the validation image can be a comparison of the distance between components of the mobile device. If the distances between the components in the first image match the distances between the components in the validation image, a match can be determined, and the at least-partially-assembled device can be approved for further assembly or completion of assembly. If there is no match, assembly of the at least-partially-assembled device is discontinued, and the failed partially-assembled device can be discarded.

Similarly, in another implementation, the comparison of the first image and the validation image can be a comparison of the distance of the components in the first image from a predetermined point in the first image with the distance of components in the first validation image from a fixed point of the first validation image. In other words, a distance measured between a component and a predetermined point in the first image is compared to the distance measured between a similar component and a fixed point in the validation image. If the distance measured in the first image matches the distance measured in the validation image, the at least partially-assembled device can be approved for further assembly.

In at least one other implementation, a comparison of more than one component in the first image can be compared to the components in the validation image to determine whether or not to approve the at least-partially-assembled device depicted in the first image for further assembly or completion of assembly. Alternatively, in another implementation, images of individual components of the at least-partially-assembled device can be captured and compared to images of the individual components of an approved mobile device.

In yet another implementation of the method of verifying assembly components of a mobile device, images can be taken at different stages of assembly of the mobile device, and each image can be compared to a validation image for that particular stage. In such an implementation, the at least partially-assembled devices are verified multiple times before the device is completely assembled. For example, the at least-partially-assembled device progresses along the assembly line from stage to stage based upon approval of the images captured of partially-assembled device when compared to the validation images at each stage where images of the at least-partially-assembled device are taken. In at least one implementation, the partially-assembled device will not enter the next state of assembly if the images of the at least partially-assembled device do not match the validation images.

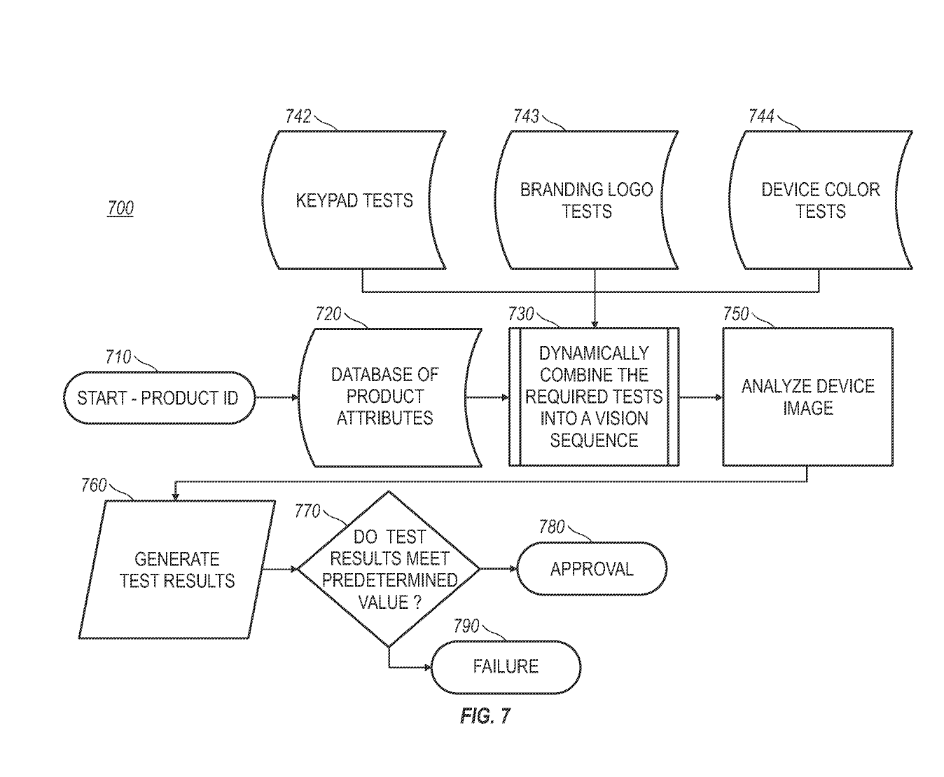

In another method as illustrated in FIG. 7, the method starts with the selection of a product identification code block 710. The product identification code can be as described above. The selection of the product identification code can include selection from a drop down menu, manual input, a look up tool, or the like. The product identification code is then used in conjunction with a database of product attributes to create a correspondence between the product identification code and product attributes such as the keyboard and other components as described above, block 720. The validation apparatus can then link together tests associated with the defined components for the product identification code to create a combined test, block 730. The combined test can be based on keyboard tests 742, branding logo tests 743, and device color tests 744. In other implementations other tests can be used in addition or instead of these tests. Likewise, as described above, the test can be for a single stage of the assembly of the device or the test can be a test that is run for a particular stage of assembly with multiple tests being performed across two or more stages of assembly. Once the test or tests are created, the device is analyzed at one or more of the stages of assembly, block 750. Test results are generated based upon the one or more tests that are performed, block 760. Then, a determination is made as to whether the device passes the tests, for example as described above this can be exceeding a predetermine value, block 770. If the device meets the requirements of the test or tests, a verification code that is an approval code is generated, block 780. If the device does not meet the requirements of the test or tests, then a verification code that is a failure code is generated, block 790. This method can be used in conjunction with the above described methods so as to enable the selection of a product to be tested using a product identification code and a database of components that are associated with a particular product identification code.

In any implementation of the apparatus or method of verifying the assembly components of a mobile device as described herein, the possibility that an incorrect mobile device is mixed in the shipment of assembled mobile devices for a particular customer or a particular carrier is decreased. For example, with the apparatus or method of verifying the assembly components of a mobile device as described herein, the distributor of the assembled devices can ensure that the appropriate devices are assembled and shipped to the appropriate customer. Possibilities that a mobile device variant having components meant for another customer are decreased, as the mobile devices having the incorrect components are removed from the assembly line since the device will fail the verification process. Additionally, if customer provides the distributor with specification as to how the customer wants the devices assembled, the method and apparatus described herein reduces the possibility that components that are not included in the customer's specifications will be assembled with the mobile devices shipped to the customer. As devices that are not approved by the method and apparatus for verifying assembly components of mobile devices are discontinued from further assembly, a distributor can ensure that the customer will receive mobile devices that are assembled according to the customer's specifications.

The method and apparatus for verifying assembly components of a mobile device as described herein can provide a more efficient and more economical method of assembling mobile devices. For example, as partially-assembled devices that fail the verification method are removed from further assembly, components that could be used on approved devices are not wasted on the failed partially-assembled devices. Additionally, as the validation apparatus discontinues the assembly of failed partially-assembled devices, the partially-assembled devices can be recycled or the components of the partially-assembled devices can be disassembled and re-used. Moreover, with the method and apparatus described herein, less time is spent on assembling failed partially-assembled devices. As assembling devices using the method or apparatus described herein requires less time and fewer wasted components, a more cost-effective assembly of devices results.

The technology described herein can take the forms of hardware, software or both hardware and software elements. In some implementations, the technology is implemented in software, which includes, but is not limited to, firmware, resident software, microcode, a Field Programmable Gate Array (FPGA) or Application-Specific Integrated Circuit (ASIC), etc. In particular, for real-time or near real-time use, an FPGA or ASIC implementation is desirable.

Furthermore, the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums as signal carriers per se are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the technology can be centralized or distributed (or a combination thereof) as known to those skilled in the art. Additionally, the memory can be a non-transitory computer readable medium and can include processor executable instructions and data structures that implement aspect of the subject innovation.

Even more, the present technology can take the form of hardware, or both hardware and software elements. In some implementations, the technology is implemented in software, which includes but is not limited to firmware, resident software, microcode, a Field Programmable Gate Array (FPGA) or Application-Specific Integrated Circuit (ASIC), etc. In particular, for real-time or near real-time use, an FPGA or ASIC implementation is desirable.

Furthermore, the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums as signal carriers per se are not included in the definition of physical computer-readable medium). Examples of a physical computer-readable medium include a semiconductor or solid state memory, removable memory connected via USB, magnetic tape, a removable computer diskette, a random access memory (RAM), a read-only memory (ROM), a rigid magnetic disk, an optical disk, transitory memory, and non-transitory memory. Current examples of optical disks include compact disk-read only memory (CD-ROM), compact disk-read/write (CD-R/W), DVD, and Blu Ray™. Additionally, Non-transitory memory also can store programs, device state, various user information, one or more operating systems, device configuration data, and other data that may need to be accessed persistently. Both processors and program code for implementing each medium as an aspect of the technology can be centralized or distributed (or a combination thereof) as known to those skilled in the art.

A data processing system suitable for storing a computer program product of the present technology and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem, Wi-Fi, and Ethernet cards are just a few of the currently available types of network adapters. Such systems can be centralized or distributed, e.g., in peer-to-peer and client/server configurations. In some implementations, the data processing system is implemented using one or both of FPGAs and ASICs.

While the exemplary implementations have been described hereinabove regarding a method of verifying assembly components of a handheld mobile communication device, the method can be implemented to verify assembly components of a mobile electronic device, a portable music player, a cellular phone, a personal digital assistant, or any other mobile device that comprises an assembly of components. Additionally, while the illustrated implementations described herein describe verifying the assembly components of partially-assembled devices, one of ordinary skill in the art will appreciate that the method for verifying assembly components can be a verification of the components of a full-assembled or completely-assembled device. Moreover, one of ordinary skill will appreciate that the elements and features from the illustrated implementations herein can be optionally included to achieve the described benefits of the presently disclosed system and method for determining a location-based preferred media file.

Various modifications to and departures from the disclosed implementations will occur to those having skill in the art. The subject matter that is intended to be within the spirit of this disclosure is set forth in the following claims.

What is claimed is:

1. A method for verifying assembly components of a mobile device comprising:
receiving first image data, at a processing module, of at least a partially-assembled device having at least two components;
in response to the receiving, comparing, at the processing module, the first image data with a first validation image of at least a partially-assembled device;
in response to the comparing, generating a certification code in the event the comparison of the components in the first image and the components of the first validation image contain substantially equivalent components.

2. The method according to claim 1, wherein the first image is of the partially-assembled device at a first stage.

3. The method according to claim 1, wherein the first validation image comprises individual images of one or more of the components.

4. The method according to claim 1, wherein the comparison of the components in the first image and the components of the first validation image includes matching the shape of the components in the first image with the components of the validation image and assigning a match coefficient based upon difference between of components in the first image and the first validation image.

5. The method according to claim 4, further comprising approving the partially-assembled device based at least partially upon the match coefficient exceeding a predetermined value.

6. The method according to claim 1, wherein the comparison of the components in the first image and the components of the first validation image includes matching a distance of the components from a predetermined point in the first image with the distance of components from a fixed point of the first validation image and assigning a match coefficient based upon difference between of components in the first image and the first validation image.

7. The method according to claim 1, further comprising
receiving a second image, at the processing module of at least a partially-assembled device at a later stage than mobile device at the time of the first image;
comparing, at the processing module, the second image with a second validation image;
generating, at the processing module, a certification code in the event the comparison of the components in the second image and the components of the second validation image contain substantially equivalent components.

8. A validation apparatus comprising
a camera module;
a processing module communicatively coupled to the camera module;
the processing module programmed to
receive a request for verification of at least a partially assembled device,
receive a first image of the at least partially-assembled device having at least two components;
compare the first image with a first validation image of the at least partially-assembled device;
generate a certification code in the event the comparison of the components in the first image and the components of the first validation image contain substantially equivalent components.

9. The validation apparatus according to claim 8, wherein the first image is captured by the camera module.

10. The validation apparatus according to claim 8, wherein the camera module is an overhead camera module.

11. The validation apparatus according to claim 8, wherein the first validation image comprises individual images of one or more of the components.

12. The validation apparatus according to claim 8, wherein the first validation image is derived from a model of the device.

13. The validation apparatus according to claim 8, wherein the processing module is further programmed to
receive a second image of at least a partially-assembled device at a later stage than the device at a time of the first image;
compare the second image with a second validation image;
generate a certification code in the event the comparison of the components in the second image and the components of the second validation image contain substantially equivalent components.

14. The validation apparatus according to claim 8, wherein the request is based on a selection of a product identification code.

15. The validation apparatus according to claim 14, wherein the first image is selected based upon the product identification code.

16. A method for verifying assembly components of a mobile device comprising:
receiving first image data of at least a partially-assembled device;
comparing the first image data with a first validation image;
approving the mobile device in the event the comparison of the components in the first image and the components of the first validation image contain substantially equivalent components.

17. The method according to claim 16, wherein the comparison of the components in the first image and the components of the first validation image includes matching the size of the components in the first image with the components of the first validation image and assigning a match coefficient based upon difference between of components in the first image and the first validation image.

18. The method according to claim 17, wherein the approval of the partially-assembled device is at least partially based upon the match coefficient exceeding a predetermined value.

19. The method according to claim 16, wherein the comparison of the components in the first image and the components of the first validation image includes matching a color of the components in the first image with the components of the first validation image and assigning a match coefficient based upon difference between of components in the first image and the first validation image.

20. The method according to claim 19, wherein the approval of the partially-assembled device is at least partially based upon the match coefficient exceeding a predetermined value.
